(19) United States
(12) Patent Application Publication
(10) Pub. No.: US 2008/0087491 A1
(43) Pub. Date: Apr. 17, 2008

(54) Steering System

(75) Inventors: Dieter Ammon, Remseck (DE); Michael Decker, Boeblingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 11/578,422

(22) PCT Filed: Mar. 31, 2005
(86) PCT No.: PCT/EP05/03354

§ 371 Date: Aug. 10, 2007

(30) Foreign Application Priority Data
Apr. 14, 2004 (DE) 10 2004 017 987.5
May 25, 2004 (DE) 10 2004 025 554.7

(51) Int. Cl. B62D 5/06

(52) U.S. Cl. 180/426

(57) ABSTRACT

A steering system for a vehicle has a steering wheel that is mechanically connected to the steerable vehicle wheels via a steering column. An actuating device is actuated by a control device to generate an actuating device holding torque that acts in the steering column. The actuating device has two friction elements that can be placed in frictional contact. The actuating device holding torque is variable and depends on the friction force generated between the two friction elements. The reaction torque that acts on the steering wheel when there is steering intervention which is independent of the driver can be reduced or compensated by the actuating device holding torque.

### RELATED APPLICATIONS

This application is a National Phase Entry under 35 U.S.C. § 371, of International Application No. PCT/EP2005/003354, filed Mar. 31, 2005, which claims priority to German Patent Application No.'s DE 10 2004 017 987.5, filed Apr. 14, 2004, and DE 10 2004 025 554.7, filed May 25, 2004. The disclosures of each of which are incorporated herein by reference in their entirety.

### BACKGROUND AND SUMMARY OF THE INVENTION

The present invention relates to a steering system for a vehicle in which the steering system, the steering wheel of the vehicle has a positive mechanical coupling to the steerable vehicle wheels.

DE 102 20 123 A1 discloses a superimposition steering system with a superimposition device. The handling variable which is generated by the steering activation of the steering handle and a superimposition variable which is generated by a superimposition actuator are superimposed by the superimposition device to form an output variable. The steering angle is set at the steering vehicle wheels by a steering actuator in accordance with the output variable.

When the superimposition actuator is actuated, a reaction torque always occurs from the superimposition device back to the steering wheel, and the reaction torque can be sensed by the driver. An active steering intervention which is independent of the driver is possible by way of the superimposition actuator only if the driver supports the reaction torque. Reaction torques which occur unexpectedly can irritate the driver, in particular at relatively high velocities of the vehicle.

An object of the present invention is to provide a steering system which improves the possibilities for active steering interventions which are independent of the driver.

This object is achieved, on one hand, by providing an actuating device with two friction elements that can be placed in frictional contact. The actuating device holding torque is variable and depends on the friction force generated between the two friction elements. The actuating device holding torque can reduce the reaction torque which is caused during the activation of the superimposition actuator and which acts on the steering wheel, and if necessary it can also be compensated. As a result of the type of embodiment of the actuating device, either as a friction brake element or friction clutch element, a simple and cost-effective embodiment of the actuating device can be implemented.

With the steering system according to the invention interventions into the vehicle movement dynamics can be performed. It is known, for example, to use vehicle movement dynamic systems such as ESP systems to influence the steering as an alternative, or in addition to activating the brakes if the vehicle has an actual yaw rate which differs from the setpoint yaw rate. Such steering interventions can be carried out with the steering system according to the invention without reactions that are irritating for the driver occurring as a result of the active steering intervention in the steering handle.

Without the actuating device provided in addition to the superimposition actuator, the reaction torque could not be influenced as a result of a steering intervention in the steering wheel that is independent of the driver. In the event of a steering intervention—for example by the additional steering angle that is set independently of the driver or the additional steering torque which is set independently of the driver—the reaction torque would be produced as a function of the transmission ratio that is mechanically predefined by the structure of the steering system. The driver is supported by the steering system according to the invention when steering his vehicle and not irritated or unsettled by unexpected reaction torques on the steering wheel.

Furthermore, the steering system according to the invention can increase comfort. For example, lateral dynamic interference variables acting on the vehicle can be selectively suppressed without disruptive reactions at the steering wheel. The straight-ahead travel of the vehicle can be improved and interference torques that are transmitted from the wheels to the steering wheel, for example owing to unevennesses in the carriageway, can be reduced.

Furthermore, as already mentioned, vehicle movement dynamic steering interventions are made possible, for example in order to control the yaw rate, in which case owing to the reaction torque which can be influenced there is no restriction on the influencing of the steering angle independently of the driver. The functionality of the present steering system comes very close to being a concept of a so-called “steer-by-wire” steering system even though there is a mechanical connection between the steering handle and the steered wheels here.

It is advantageous if a setpoint reaction torque is predefined permanently or as a function of parameters and the reaction torque is set in accordance with the setpoint reaction torque. This measure allows desired reaction torques to be set in order to provide haptic information to the driver about the current driving situation of the vehicle without there being the risk of irritating the driver. The setpoint reaction torque can also be approximately zero here, in which case it is then not possible to sense a reaction at the steering wheel.

In a simple-to-implement configuration, the actuating device acts on the first steering column section that connects the steering wheel and the superimposition device.

Because the first friction element can be moved relative to the second friction element, and the second friction element is arranged fixedly with respect to at least one section of the steering column, a simple structural configuration can be obtained because just one of the friction elements is mounted in a movable fashion.

The actuating device can contain a friction coupling that has the two friction elements and is inserted into the steering column. The larger the friction torque, the larger is also the torque that can be transmitted by the friction clutch.

The steering system is advantageously embodied as an electrical, hydraulic or electro-hydraulic power steering system. In this case, the actuating device may be a component of the power steering device so that components of the power steering system which are already present in any case can be simultaneously used as an actuating device. As a result, the expenditure on components and the costs incurred can be reduced.

The actuating device can also be embodied so as to be capable of being activated fluidically, as a result of which actuating device holding torques that are larger in absolute terms than with an actuating device that is activated electrically can be obtained.

In this context, the first friction element can be formed by a sealing arrangement that bears, on one hand, against the steering column and, on the other hand, against a housing part which surrounds the steering column and is arranged so as to be rotationally fixed relative to the steering column, and that causes a friction force between the steering column and the housing part. The absolute value of the friction force can vary as a function of a fluid pressure that acts on the sealing arrangement. The amount of space required is very low in this embodiment.

Other objects, advantages and novel features of the present invention will become apparent from the following detailed description of the invention when considered in conjunction with the accompanying drawings for example.

### BRIEF DESCRIPTION OF THE DRAWINGS

FIG. 1 is a schematic illustration of a first exemplary embodiment of a steering system with a superimposition device which is embodied as a hydraulic power steering system,

FIG. 2 is a schematic illustration of a first exemplary embodiment of an actuating device which has a friction clutch,

FIG. 3 is a schematic illustration of a second exemplary embodiment of an actuating device with a disc brake device, and

FIG. 4 is a schematic illustration of a third exemplary embodiment of an actuating device with a sealing arrangement.

### DETAILED DESCRIPTION OF THE DRAWINGS

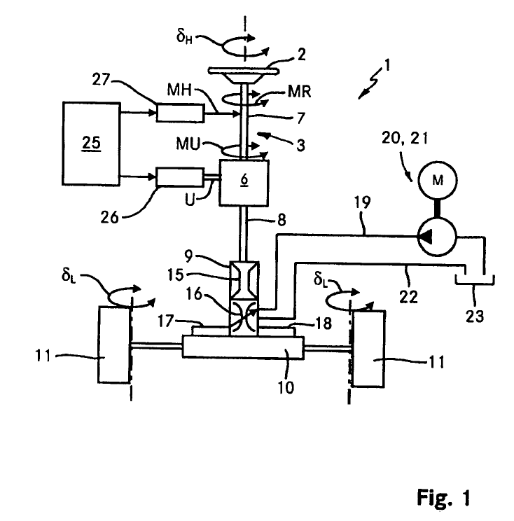

FIG. 1 shows a steering system 1 that has a steering wheel 2 connected via a steering column 3 to a steering actuator 10 that is provided for setting the steering angle δ_{L} at the steerable vehicle wheels 11. The steering system 1 also has a superimposition device 6 which is connected to the steering wheel 2 via a first section 7 of the steering column 3. The superimposition device 6 is connected to the steering actuator 10 via a second section 8 and, for example a, hydraulic power steering device 9.

The superimposition device 6 is implemented as a ratio gear unit in all the exemplary embodiments illustrated here.

The hydraulic power steering device 9 has a setting element 15 that sets the valve opening of a steering valve 16 of the power steering device 9 as a function of an activation variable. A first actuation line 17 and a second discharge line 18 connect the steering valve 16 to the steering actuator 10. The steering valve 16 is connected via a feed line 19 to a pressure source 20, for example to the delivery side of an engine pump unit 21. A return line 22 connects the steering valve 16 to a reservoir vessel 23. In the exemplary embodiment described here, the setting element 15 is formed by a rotary rod that senses, as activation variable, the activation torque or the activation angle that bears against the second section 8 of the steering column 3. The valve opening of the steering valve 16 is varied as a function of the direction and the absolute value of the activation variable. As a result, an auxiliary force for activating the steering actuator 10 is brought about in accordance with the activation variable.

The superimposition device 6 is connected to a superimposition actuator 26 that can be actuated by a control device 25. The superimposition actuator 26 can be formed by an electric motor and generate a superimposition variable U that is formed, according to the example, by a superimposition angle, that variable being transmitted mechanically to the superimposition device 6.

The control device 25 also actuates an actuating device 27 that can also be formed by an electric motor and serves to reduce and compensate the reaction torque MR that can be felt at the steering wheel 2 by the driver. For this purpose, an actuating device holding torque MH, which acts on the first section 7 of the steering column 3, can be generated by the actuating device 27.

The actuating device 25 determines, on the basis of one or more input signals such as, for example, the longitudinal velocity of the vehicle, the actual yaw rate, the attitude angle, the lateral acceleration, etc., which superimposition variable U and which actuating device holding torque MH is to be set. As a result, the reaction torque MR that acts on the steering wheel 2 can be reduced to the desired degree or completely compensated. Such input signals, in particular input signals that describe the current longitudinal dynamic state and/or lateral dynamic state of the vehicle can either be sensed by sensor apparatus in the vehicle or determined from sensor variables. In modern vehicles, many such input variables are already available on a vehicle data bus.

When there is a steering intervention that is independent of the driver, a reaction torque MR that acts on the steering wheel is brought about, and results in the present invention from a superimposition torque MU that is caused by the superimposition actuator, and from the actuation device holding torque MH.

As a result of the additional degree of freedom provided by the actuating device 27, the steering column 3 can be held counter to the superimposition torque MU by the holding torque MH of the actuating device, in order to influence the reaction torque MR. In this context, the desired setpoint reaction torque can also be unequal to zero in absolute terms, in order to give the driver desired haptic feedback about the steering intervention which is independent of the driver. If the setpoint reaction torque MR is selected to be approximately equal to zero in absolute terms, the actuating device holding torque MH must be selected to be such that the superimposition torque MU is compensated for. When there is an actuating device 27 which acts between the superimposition device 6 formed by the superimposition gear unit, and the steering wheel 2 on the first section 7 of the steering column 3, the actuating device holding torque then corresponds to the negative superimposition torque MU: MU=−MU.

As an alternative to permanently predefining the setpoint reaction torque, the setpoint reaction torque can be predefined in a parameter-dependent fashion by a characteristic curve and/or a characteristic diagram and/or a calculation model. One or more of the following variables or variables that are correlated therewith can be used as the parameters: the longitudinal velocity of the vehicle, the longitudinal acceleration of the vehicle, the lateral acceleration of the vehicle, yaw rate, wheel speeds, steering wheel angle, angular velocity of the steering wheel, angular velocity at the output of the superimposition device 6 or the second section 8 of the steering column 3, angular velocity of a pinion that acts on the steering actuator 10, the auxiliary force that is made available at the steering actuator 10 by way of the boosting device 9, the hydraulic pressures prevailing in the actuation lines 17, 18 or in the steering actuator when there is a hydraulic boosting device 9, the steering torque at the steerable vehicle wheels 11, the motor current of the superimposition actuator 26 that is embodied as an electric motor or of the actuating device 27 that is embodied as an electric motor, the actuating device holding torque MH, the superimposition torque MU that is brought about by the superimposition actuator 26, and wheel braking torques at one or more of the vehicle's wheels.

The characteristic curve, the characteristic diagram and the calculation model can also be updated during the driving mode here.

In contrast to the first exemplary embodiment according to FIG. 1, the boosting device 9 could be arranged in the first section 7 of the steering column 3 so that the second section 8 of the steering column 3 connects the output of the superimposition device 6 directly to the input of the steering actuator 10. The actuating device 27 can act here between the steering wheel 2 and the boosting device 9 and/or between the boosting device 9 and the superimposition device 6 at the first section 7 of the steering column.

Furthermore, the steering system 1 could also be embodied as an electric power steering system. In a modification of the illustrated exemplary embodiment, a steering system 1 can be provided with a plurality of actuating devices 27 that act at a plurality of points.

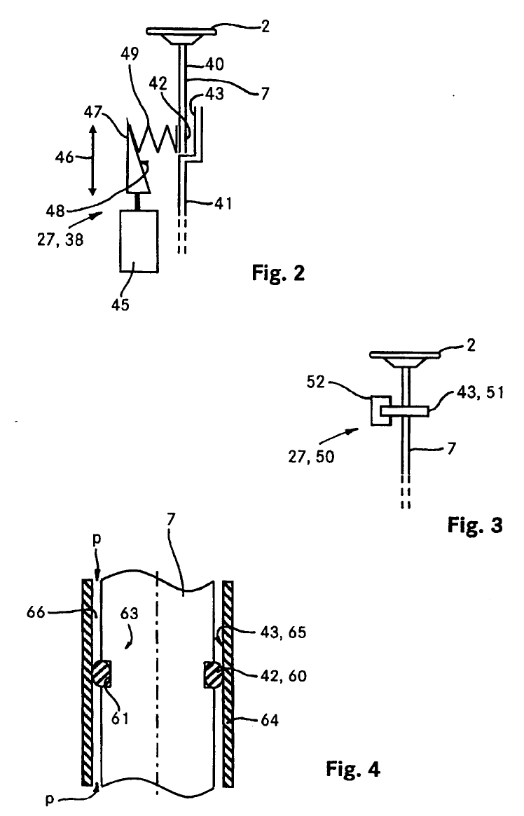

FIG. 2 shows a first embodiment of the actuating device 27 configured as a friction clutch 38. The first section 7 of the steering column 3 that is connected to the steering wheel 2 is interrupted, as a result of which a first section component 40 that is connected to the steering column 2 and a second section component 41 that is connected to the superimposition device 6 are formed.

The actuating device 27 has a first friction element 42 and a second friction element 43. The two friction elements 42, 43 are arranged between the two friction components 40, 41. The first friction element 42 is connected to the free end of the first section part 40, and the second friction element 43 is connected to the free end of the second friction part 41 or is formed by it.

The friction clutch 38 also has a coupling wedge 47 that can be moved by a clutch motor 45 essentially in the direction 46 of the extent of the steering column 3. The coupling wedge 47 tapers, viewed in the extent direction 46, and thus forms a wedge face 48 that runs obliquely with respect to the extent direction 46. Supported on the wedge face 48 is an elastic activation element 49 whose other end is connected to the free end of the first section component 40 of the first section 7 of the steering column 3 and thus to the first friction element 42. The elasticity of the activation element 49 allows play in the friction clutch 38 to be compensated.

Depending on the movement position of the clutch wedge 47, the actuation part 49 is pressed with more or less force against the first friction element 42, as a result of which the pressing force prevailing between the first friction element 42 and the second friction element 43 can be increased or decreased. If the pressing force between the friction elements 42, 43 is low or equal to zero, only a small torque, or no torque at all, can be transmitted between the two section components 40, 41. The friction clutch 38 is then in its opened state. The reaction torque MR that is transmitted from the second section element 41 to the steering wheel 2 via the first section element 40 is therefore also small or equal to zero. If the friction clutch 38 is, on the other hand, closed completely, i.e. if the two friction elements 42, 43 and thus the two section components 40, 41 are pressed one against the other with maximum possible pressing force so that in an extreme case no slip whatsoever occurs, a torque can be transmitted completely between the section elements 40, 41. When the friction clutch 38 is closed completely, the reaction torque MR acts in an unreduced manner on the steering wheel 2. The clutch motor 45—for example an electric motor—is actuated so that the clutch wedge 47 can be moved by the control device 25.

FIG. 3 shows an alternative, second embodiment of an actuating device 27. In this embodiment, the actuating device 27 is a disc brake 50. The first section 7 of the steering column 3 has a brake disc 51 that is arranged coaxially with respect to the steering column 3 and connected rotationally fixed to the first section 7 of the steering column. The brake disc 51 represents the second friction element 43 of the actuating device 27.

A brake caliper 52 with brake linings (not illustrated in more detail) is arranged on the brake disc 51 as is known from a disc brake per se, the brake linings forming the first friction element that is mounted in a movable manner. The reaction torque MR that acts on the steering wheel 2 can be reduced or compensated as a function of the friction force or braking force that is set between the brake linings and the brake disc 51. The disc brake 50 can, for example, be actuated by an electric motor, or hydraulically or pneumatically.

FIG. 4 shows a further, third embodiment of an actuating device 27, configured as a component of the boosting device 9.

The first friction element 42 is formed here by a sealing arrangement and, in the case of the embodiment shown, by a sealing ring 60. The sealing ring 60 sits, rotationally fixed, in a groove-like cutout 61 that runs in an annular shape in the circumferential direction in the outer face 62 of the first section 7 of the steering column 3.

A housing part 64 that coaxially surrounds the first section 7 of the steering column 3 in the circumferential direction and is rotationally fixed relative to the first section 7 of the steering column 3 is provided. The housing part 64 can also be formed, for example, by the housing of the boosting device 9 if the latter is arranged in the first section 7 of the steering column 3. The sealing ring 60 bears against the inner face 65, forming the second friction element 43, in the housing part 64. As a result, the sealing ring 60 between the housing part 64 and the first section 7 of the steering column forms a friction force.

An annular space 66 to which a fluid pressure p can be applied is formed between the first section 7 of the steering column 3 and the housing part 64. The sealing ring 60 can be deformed elastically by this fluid pressure p, as a result of which the friction force prevailing between the first section 7 of the steering column 3 and the housing part 64 can be changed. The greater the fluid pressure p, the greater is also the friction force. In turn, the greater the friction force between the first section 7 of the steering column 3 and the housing part 64, the greater is also the reduction in the reaction torque MR that acts on the steering column 2. The fluid pressure p is controlled by the control device 25.

1-11. (canceled)

12. A steering system for a vehicle, comprises:
a steering wheel connected to the steerable vehicle wheels via a steering column.
a superimposition actuator actuable independently of a vehicle driver by a control device for generating a superimposition variable,
a superimposition device configured to superimpose a steering wheel variable describing steering activation of the steering wheel and a superimposition variable to form an output variable,
a steering actuator for setting a steering angle at the steerable vehicle wheels as function of the output variable,
and an actuating device actuable by the control device for generating an actuating device holding torque that acts on the steering column, wherein
the actuating device has friction elements adapted to be placed in frictional contact, and the actuating device holding torque is variable and depends on the friction force generated between the friction elements.

13. The steering system as claimed in claim 12, wherein at least one of the superimposition actuator and the actuating device are actuated so that a reaction torque acting upon the steering wheel is produced, and a setpoint reaction torque is predefined permanently or as a function of parameters, with the reaction torque being set in accordance with the setpoint reaction torque.

14. The steering system as claimed in claim 13, wherein the setpoint reaction torque is essentially zero.

15. The steering system as claimed in claim 12, wherein the actuating device acts on the first steering column section that connects the steering wheel and the superimposition device.

16. The steering system as claimed in claim 12, wherein a first of the friction elements is moveable relative to a second of the friction elements, and the second friction element is fixed with respect to at least one section of the steering column.

17. The steering system as claimed in claim 12, wherein the actuating device comprises a friction coupling having the friction elements.

18. The steering system as claimed in claim 12, wherein the actuating device is configured to be activated fluidically.

19. The steering system as claimed in claim 18, wherein a first of the friction elements is formed by a sealing arrangement which bears against the steering column and, also against a housing part surrounding the steering column, the sealing arrangement being rotationally fixed and causing a friction force between the steering column and the housing part, the absolute value of the friction force being variable as function of a fluid pressure acting on the sealing arrangement.

20. The steering system as claimed in claim 12, wherein the steering system is a power steering system having a power steering device that generates an auxiliary force to assist the vehicle driver in carrying out a steering activation of the steering wheel.

21. The steering system as claimed in claim 20, wherein the actuating device is a component of the power steering device.

22. The steering system as claimed in claim 12, wherein the actuating device comprises a brake device.

23. The steering system as claimed in claim 22, wherein the brake device is a disc brake.
